(19) United States
(12) Patent Application Publication
(10) Pub. No.: US 2006/0185123 A1
(43) Pub. Date: Aug. 24, 2006

(54) Hinge device of portable equipment and portable telephone

(76) Inventor: Ryuta Kuramochi, Yokohama (JP)

Correspondence Address: NOTARO AND MICHALOS, 100 DUTCH HILL ROAD, SUITE 110, ORANGEBURG, NY, 10962-2100, US

(21) Appl. No.: 11/355,873

(22) Filed: Feb. 16, 2006

(30) Foreign Application Priority Data
Feb. 22, 2005 (JP) 2005-045441

(51) Int. Cl. E05D 7/00

(52) U.S. Cl. 16/221

(57) ABSTRACT

To provide a hinge assembly with a good operability for a portable equipment composed of a first case body and a second case body, such as a portable telephone and a portable video game machine, etc., the above-indicated first case body and second case body are structured, allowing a relative rotation from a closing condition, i.e. a superposition of the above-indicated case bodies in two directions, i.e. a longitudinal and right and left direction. Further a locking mechanism is used to prevent the above-described bodies from opening in either one direction, when they are opened in either other one of two of the above-indicated directions.

### BACKGROUND OF THE INVENTION

1. Field of the Invention

The present invention relates to a hinge device of portable equipment, namely a device suitable for use in portable equipments including foldable telephone in which a first case body with a keyboard portion and microphone portion, etc. and a second case body with a display portion and a speaker portion, etc. are configured to be both opened and closed, and further to a portable telephone provided with said hinge device.

2. Description of Related Art

Among portable telephones which belong to portable equipment, foldable ones are marketed; these foldable portable telephones have a first case body which includes a keyboard portion and a microphone portion, etc. on one hand, and a second case body which comprises a display portion and a speaker portion, etc. on the other; further in these foldable portable telephones the above two case bodies are rotatably interconnected by means of a hinge device. In the above-mentioned foldable portable telephones the second case body is rotatably connected via a hinge device with the rear portion of the top surface of the first. This configuration allows the above two case bodies to be superposed on each other to be closely contacted, further realizing a closure of a transmitter portion, while due to the same configuration one of the case bodies is to be released from a superposition (a closing condition) thereof on the other to expose the same transmitter position. The above can be alternatively described as follows: normally the first case body superposes the second and in this closing condition the transmitter portion is concealed; the user can use the portable telephone in an opening condition, and for obtaining such a condition, he rotates the second case body with regard to the first, with one of his hands on the first and the other on the second, so as to expose the transmitter portion (i.e. to set the lower surface of the second case body apart from the transmitter portion).

In the recent years, another kind of portable telephones found in the market include various functions as those using communication lines as internet and video games, and not limited to a call. Such portable telephones cannot fulfill their functions, since display portions thereof are only available while opened in a longitudinal direction of a case body on other side: hinge devices for portable telephones described here connect a first and a second case body with each other so as to be rotatable in the longitudinal direction of either one of the case bodies around a straight line in the right and left direction thereof, i.e. realize a closing/opening in only one direction. Accordingly the display portions are available only for use in a position where opened in a longitudinal direction of a case body on other side. Therefore a further kind of portable telephones is proposed, wherein, in addition to a closing and an opening in a longitudinal direction of a first and second case body, for closure and exposure of transmitter portion, a closing and an opening in a right and left direction of a first and second case body are also possible. A document thereof, Japanese Laid-Open No. 2003-110673, is known to the public.

This reference 1 sets forth a hinge device for opening and closing the first and second case bodies in two directions. The hinge device according to this reference interconnects the first and second case bodies, allowing these case bodies to be opened and closed not only in the longitudinal direction, around a first axis in the right and left direction, but also in the right and left direction, around a second axis in the longitudinal direction. As a result, a display portion of the portable telephone can be used both having longer sides thereof up and having shorter sides up. However, in the mid-course of closing/opening operation of the case bodies in one direction, e.g. in a longitudinal direction, and with a second case body completely opened in an opening condition, the second case body can also be rotated in another direction, e.g. in the right and left direction. Therefore, the second case body is rotated with regard to the first also in other direction although only a rotation in one concrete direction is desired, and it is difficult to achieve a closing/opening operation only in one desired direction, sometimes providing difficulties for the closing/opening operation itself.

### SUMMARY OF THE INVENTION

For solving the above-mentioned problems, the present invention has an object to provide a hinge device of portable equipment and portable telephone using the same for facilitating the closing/opening operation, and especially enabling a first case body and a second case body to be opened and closed in two directions (a longitudinal direction and a right and left direction).

To achieve the above object, in an aspect of the present invention, a hinge device of a portable equipment relatively opens and closes a first case body and a second case body of said portable equipment in either one of two directions, a longitudinal direction and a right and left direction, from a closing condition, where a first case body and a second case body are superimposed on each other. This hinge device includes: a first shaft which is attached to either one of the first and the second case bodies; a second shaft which is attached to either other one of the first and the second case bodies; a base portion which supports the first and the second shaft so as to be each rotatable around a respective axis; a first cam mechanism which restricts the rotation of the first shaft with regard to the base portion; a second cam mechanism which restricts the rotation of the second shaft with regard to the base portion, and; a locking mechanism which allows said first case body and said second case body, when these two bodies are in a closing condition, to be opened and closed in the above-indicated two directions, and further locks the above-indicated first and said second case bodies against closing/opening in either other of two of the above-indicated directions when said first case body and said second case body are opened in either one direction;

According to the present invention, the first and second case bodies are to be opened and closed from a closing direction in either one of two directions, and while opened in one direction, this movement causes the case bodies to be locked against an opening and closing in other direction. Therefore the second case body can be opened smoothly with regard to the first in the above described manner, in that this prevents the case bodies from an opening and closing in other direction. As a result, an opening and closing operation is facilitated.

Further to achieve the above object, in another aspect of the present invention, in the above-mentioned hinge device of a portable equipment the above-indicated locking mechanism is composed of a first cam attached to the above-indicated first shaft for rotating together with the above-indicated first shaft, a second cam attached to the above-indicated second shaft for rotating with the second shaft, and a locking member to be engaged with one of the above-indicated first and second shafts so as to be locked, when another shaft rotates to be opened in either one of two of the above-indicated directions.

Furthermore, to achieve the above object, in another aspect of the present invention, in the above-mentioned hinge device of a portable equipment it is desirable that the first cam is formed in the shape of a circle with first cam engagement concave portions on an outer circumference thereof, and that the second cam is formed in the shape of a circle with second cam engagement concave portions on an outer circumference thereof. In the meantime, it is desirable that in the hinge device according to the present invention, the locking member includes a locking shaft which can be shifted, shuttle between the above-indicated first and second shafts; in the above-mentioned hinge device, it is also desirable that the above-indicated locking shaft prevents either one of the above-indicated first and second shafts from rotating, by an intrusion of cam engagement convex portions into cam engagement concave portions of the above-indicated first and second cams, thus these two shafts are opened in either other one of two of said directions, when said first case body and said second case body are opened in either one of two of said directions.

Moreover, to achieve the above object, as another aspect of the present invention, in the above-mentioned hinge device of a portable equipment the locking shaft is biased to be engaged either with the above-mentioned first cam engagement concave portions or with the above-mentioned second cam engagement concave portions.

In addition, to achieve the above object, as another aspect of the present invention, in the above-mentioned hinge device of a portable equipment the above-mentioned locking mechanism is equipped with a first cam A memberttached to the first shaft having a cam portion and with a second cam attached to the second shaft having a cam portion; also in the above-mentioned hinge device a rotation of either one of the above-indicated first and second shafts is prevented by being engaged with a portion other than a cam portion of either other one of the above-indicated first and second shafts, when above-indicated first and second case bodies are opened by rotation of either other one of either other one of the above-indicated two shafts.

Additionally, to achieve the above object, as another aspect of the present invention, in the above-mentioned hinge device of a portable equipment the first cam mechanism is composed of a first cam A member fixed on the above-mentioned first shaft, of a first cam B member which is engaged with the base portion, able to be shifted in an axial direction of the first shaft and contacted on the surface with the first cam A member, of first cam engagement convex portions mounted at least on either one of contact surfaces of the first cams A and B, and of first cam engagement concave portions which are mounted at least on either other one of contact surfaces of the first cams A and B and engaged with the first cam engagement convex portions, for locking the first case body at a predetermined position with regard to the second case body; in the above-mentioned hinge device, the second cam mechanism is also composed of a second cam A member fixed on the second shaft, of a second cam B member which is engaged with the base portion, able to be shifted in an axial direction of said second shaft and contacted on the surface with the second cam A member, of second cam engagement convex portions mounted at least on either one of contact surfaces of the second cams A and B, and of second cam engagement concave portions which are mounted at least on either other one of contact surfaces of the second cams A and B and engaged with the second cam engagement convex portions, for locking the second case body at a predetermined position with regard to the first case body.

Besides, to achieve the above object, as another aspect of the present invention, a portable telephone includes the above-described hinge device of a portable equipment. According to the present invention, as described above, while the first and second case bodies in the closing condition are opened in one direction, they are locked against an opening and closing in other direction, thus facilitating an opening and closing operation.

As illustrated above, in a hinge device of a portable equipment and a portable telephone, when opened and closed in one direction, the case bodies are locked against an opening and closing in other direction, such operation being thus excluded. Therefore such a structure facilitates an opening and closing operation.

### BRIEF DESCRIPTION OF THE DRAWINGS

FIG. 1 is a perspective view showing an embodiment of a portable telephone equipped with a hinge device of portable equipment according to the present invention, namely in a closing condition;

FIG. 2 is a perspective view showing an embodiment of a portable telephone equipped with a hinge device of portable equipment according to the present invention, namely in an opening condition;

FIG. 3 is a perspective view showing an embodiment of a portable telephone equipped with a hinge device of portable equipment according to the present invention, namely in an opening condition;

FIG. 4 is a side view showing an embodiment of a locking mechanism according to the present invention in the embodiment of the FIG. 2;

FIG. 5 is a perspective view showing an embodiment of a locking mechanism according to the present invention in the embodiment of the FIG. 3;

FIG. 6 is a perspective view showing an embodiment of a hinge device of portable equipment according to the present invention;

FIGS. 7A to 7G are views showing an embodiment of a hinge device of portable equipment according to the present invention, FIG. 7A being a perspective view, FIG. 7B being a front view, FIG. 7C being a plan view, FIG. 7D being a back view, FIG. 7E being a back view omitting a base portion, FIG. 7F being a side view, FIG. 7G being a side view omitting a base portion;

FIGS. 8A to 8C are block views showing an embodiment of a locking mechanism according to the present invention;

FIGS. 9A to 9C are block views showing another embodiment of a locking mechanism according to the present invention;

FIGS. 10A to 10E are views showing an embodiment of a base portion according to the present invention, FIGS. 10A and 10B being perspective views, FIG. 10C being a plan view, FIG. 10D being an A-A arrow sectional view of 10C, FIG. 10E being a B-B arrow sectional view of 10C;

FIG. 11 is a perspective view showing an embodiment of a first shaft according to the present invention;

FIGS. 12A and 12B are views showing an embodiment of a second shaft according to the present invention, FIG. 12A being a perspective view and FIG. 12B being a front view;

FIGS. 13A to 13D are views showing an embodiment of a first cam A member according to the present invention, FIG. 13A being a perspective view, FIG. 13B being a side view, FIG. 13C being a front view, FIG. 13D being a plan view;

FIGS. 14A to 14D are views showing an embodiment of a first cam B member according to the present invention, FIG. 14A being a perspective view, FIG. 14B being a front view, FIG. 14C being a side view, FIG. 14D being a bottom view;

FIGS. 15A to 15D are views showing an embodiment of a second cam A member according to the present invention, FIG. 15A being a perspective view, FIG. 15B being a side view, FIG. 15C being a front view, FIG. 15D being a plan view;

FIGS. 16A to 16C are views showing an embodiment of a second cam B member according to the present invention, FIG. 16A being a side view, FIG. 16B being a front view, FIG. 16C being a bottom view;

FIG. 17 is a perspective view showing an embodiment of a locking shaft according to the present invention.

### DETAILED DESCRIPTION OF THE PREFERRED EMBODIMENT(S)

Hereinafter, a hinge device of the portable equipment and portable telephone according to the present invention will be described in detail, based on the accompanying drawings.

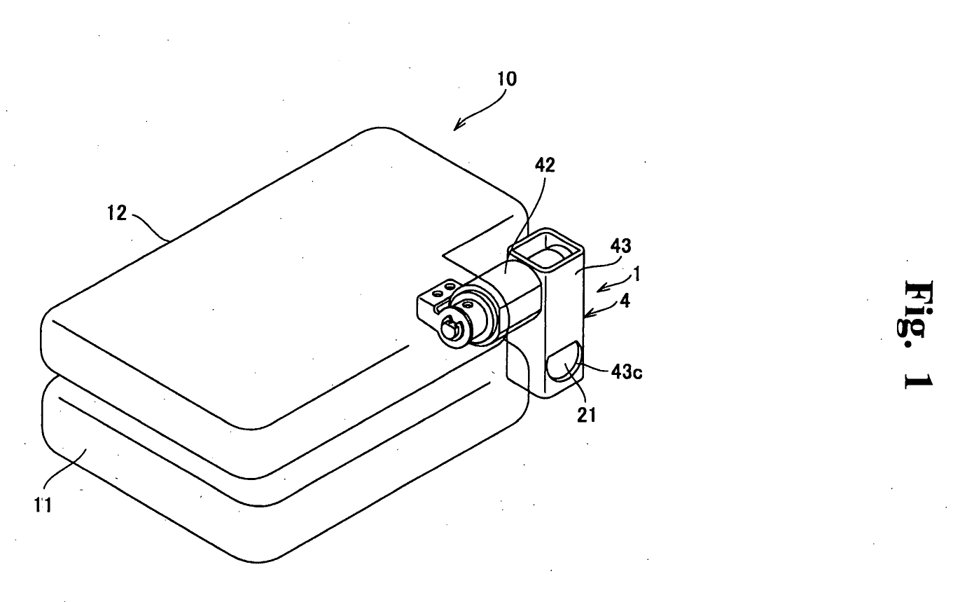

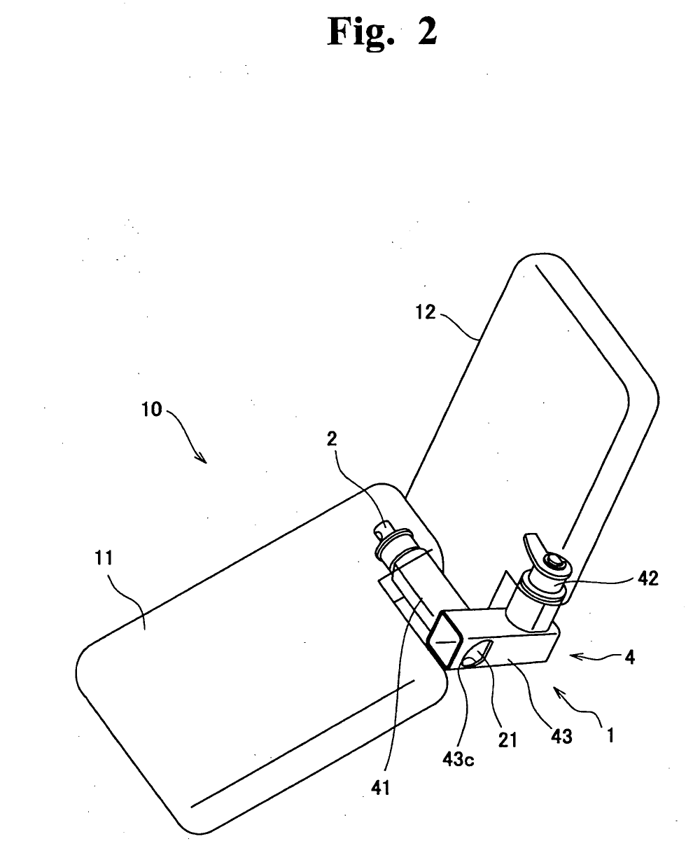

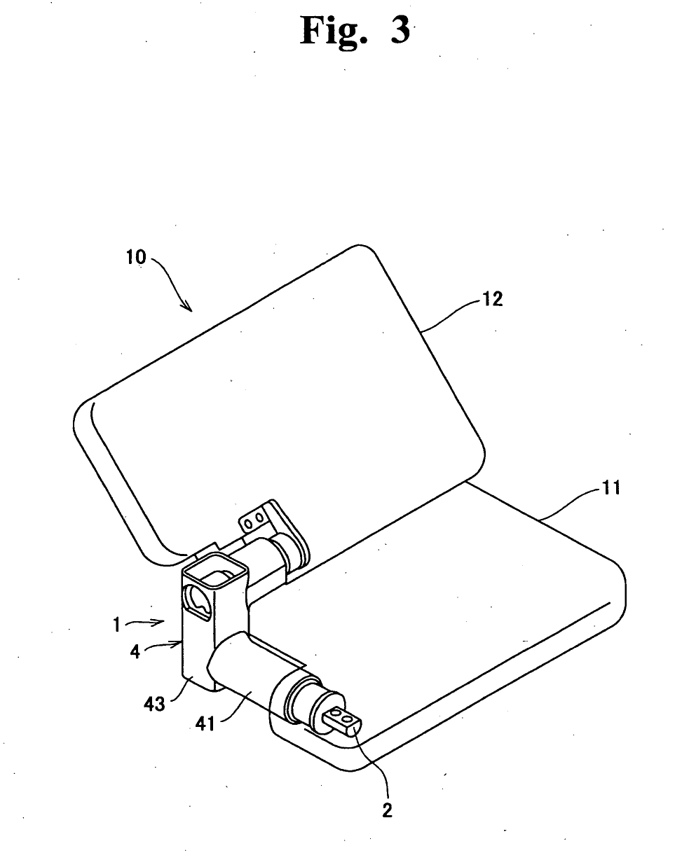

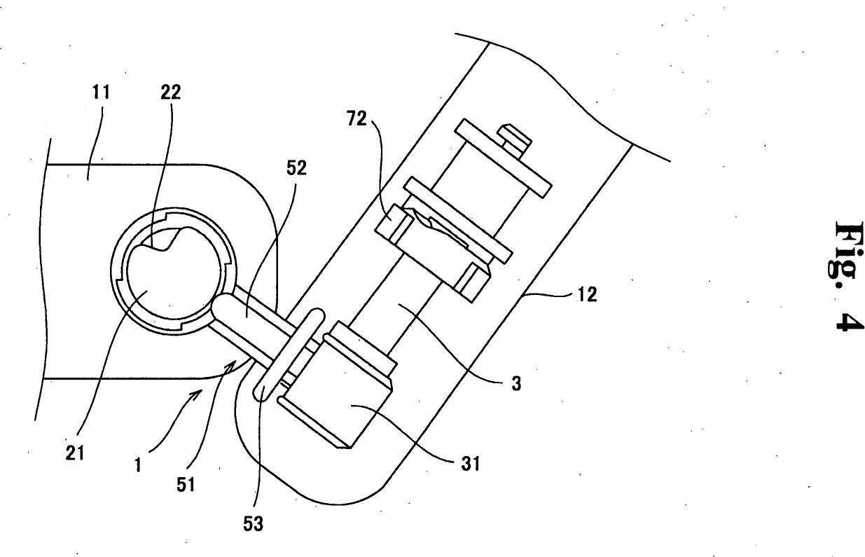

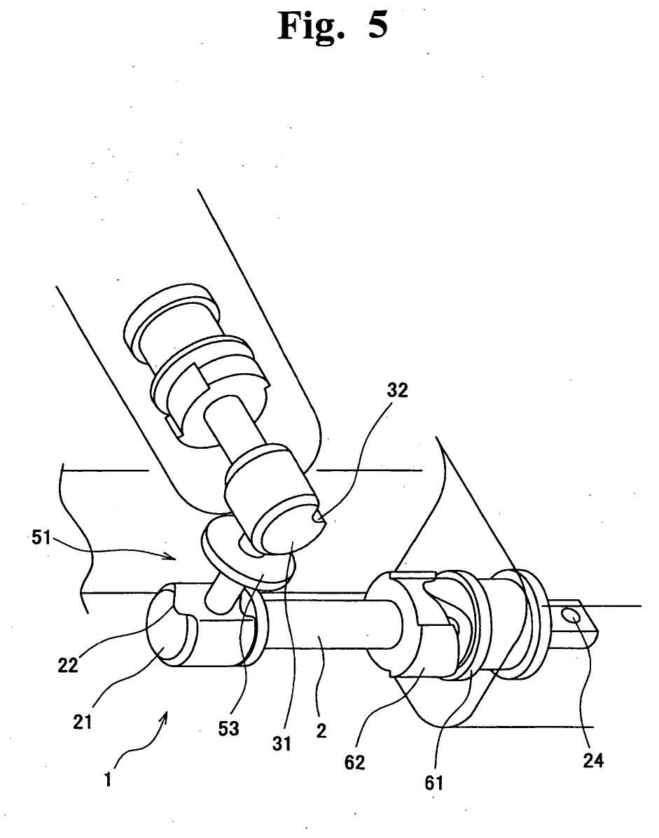

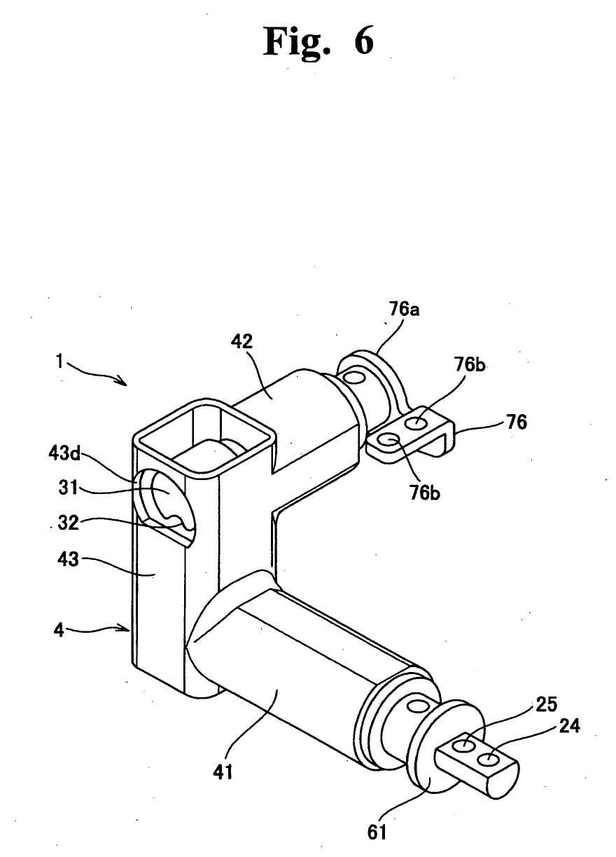

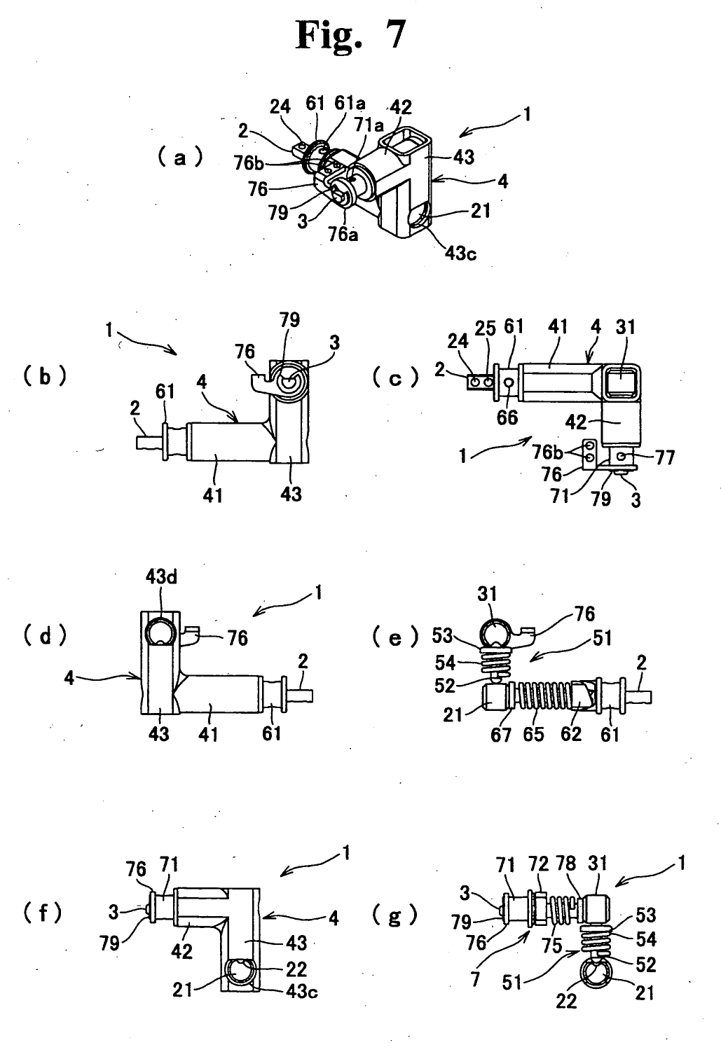

FIGS. 1 to 3 show an embodiment of a portable telephone equipped with a hinge device of the portable equipment according to the present invention; FIGS. 4 and 5 illustrate embodiments of a locking mechanism according to the present invention; FIGS. 6 and 7 present an embodiment of a hinge device of the portable equipment according to the present invention. As shown in FIGS. 1 to 7, a hinge device of a portable equipment according to the present invention connects a first case body 11 and a second case body 12 which are constituent parts of the portable equipment, so as to be opened and closed in two directions; thus it realizes a closing condition (see FIG. 1) in which a top surface of either one of the first case body 11 and the second case body 12 is covered with either other one of the first case body 11 and the second case body 12, as well as an opening condition where a top surface of either one of the above case bodies is exposed (see FIGS. 2 and 3).

A portable equipment is not particularly limited, but implies e.g. portable telephones, portable information terminals such as Zaurus™, electric calculators, pocket computers and portable video game machines; portable telephones are most favorable among the above for a hinge device according to the present invention. Furthermore, the portable equipment according to the present invention includes ashtrays, lids for case, etc. In the meanwhile, the embodiments in the following illustrate a portable telephone 10 as an example of portable equipment, however, the embodiments are not limited to portable telephones only.

A first case body 11 as a transmitter portion of the portable telephone 10 includes a keyboard portion and microphone portion, etc. on the top surface thereof. The first case body 11 is formed in an elongated and virtually rectangular shape. A second case body 12 on the other hand, as a receiver portion, has a display portion such as LCD, a speaker portion and a camera portion, etc. The second case body 12 is formed in an elongated and virtually rectangular shape which is substantially the same as the first case body 11. The first case body 11 and the second case body 12 as above described are connected with each other via a hinge device 1, allowing either one of the case bodies to be opened and closed relatively to each other in two directions, i.e. in a longitudinal direction (this may be called one of vertical directions) and a right and left direction (this may be called one of horizontal directions) thereof, this operation starting from a closing condition wherein the first case body 11 is superposed on the second case body 12; this is the structure of the portable telephone 10. In other words, in the portable telephone 10, the transmitter portion is concealed while the first case body 11 is superposed on the second case body 12, and the transmitter portion is exposed while the first case body 11 is seperated from the second case body 12.

As for a hinge device 1 according to the present invention, characteristic components thereof include: first, a first shaft 2 which is mounted on either one of a first case body 11 or a second case body 12 and stretches in the right and left direction thereof; second, a second shaft 3 which is mounted on either other one of a first case body 11 and a second case body 12 and extends in the longitudinal direction thereof; further a base portion 4 which supports the first shaft 2 and the second shaft 3 so as to be rotatable around the axis of each; furthermore a second cam mechanism 7 which restricts the rotation of the second shaft 3; in addition a locking mechanism 5 which allows, in a closing condition, the first case body 11 and the second case body 12 to rotate for being closed/opened in either one of the directions, and while the above-mentioned case bodies are closed or opened in either one of longitudinal and right and left direction thereof, locking the case bodies against being opened and closed in either other direction.

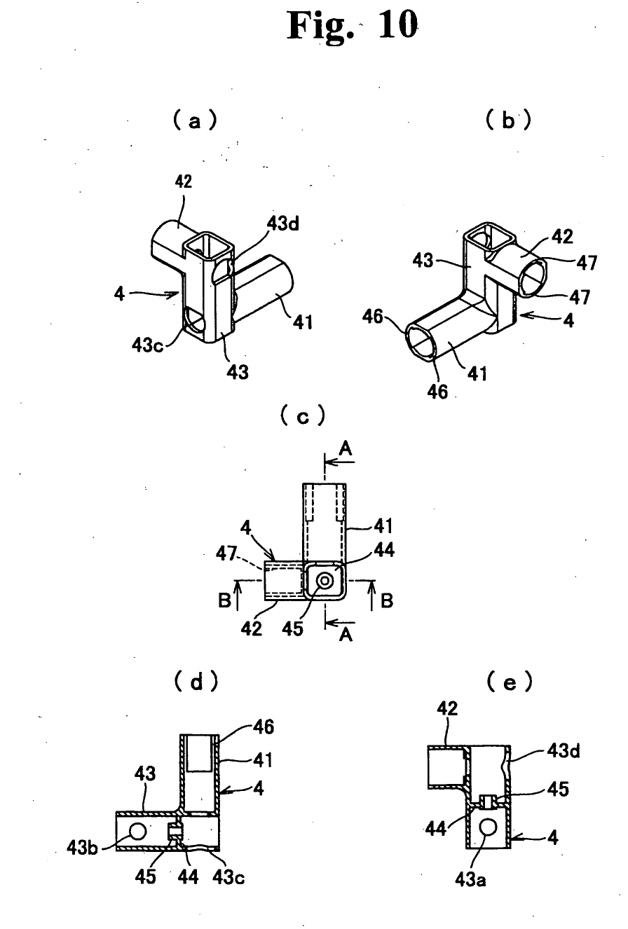

As shown in FIGS. 1 to 7 and 10, a base portion 4 is composed of a first shaft portion 41 for rotatably supporting a first shaft 2, of a second shaft portion 42 for rotatably supporting a second shaft 3, and a connecting portion 43 for connecting the first shaft portion 41 and the second shaft portion 42. The connecting portion 43 is formed in a cylindrical shape, in a substantially rectangular cylindrical shape, and in a virtually square cylindrical shape in an illustrated embodiment. The connecting portion 43 is preferably configured to have a length (in a longitudinal direction) equal to, or slightly longer or shorter than, the thickness of both of the case bodies superimposed on each other. The connecting portion 43 is disposed so as to stretch in the direction of the thickness of the first case body 11 and the second case body 12 superimposed on each other, on any of four corners thereof. At a point slightly closer to the first case body 11 from the central portion of the connecting portion 43, a compartment wall 44 is mounted for dividing the interior of the connecting portion 43. In the central portion of the compartment wall 44, the penetrating portion 45 in a cylindrical shape is mounted so as to penetrate the compartment wall 44.

A first shaft portion 41 is e.g. integrally mounted on a surface on the side of a side end portion which lies close to an end portion of a connecting portion 43 toward a first case body 11 and is shorter in length (the side end portion may be called side short end portion); the first shaft portion 41 has e.g. a virtually cylindrical shape, and stretches in the right and left direction and the direction of the side short end portion of the connecting portion 43. The first shaft portion 41 supports a first shaft 2, allowing the first case body 11 and the second case body 12 to be rotatable around the first shaft 2. On a surface of the connecting portion 43 inside the first shaft portion 41, a first through hole 43a with a smaller diameter than the first shaft portion 41 is mounted. Two portions opposing each other in the inner circumference of the first shaft portion 41, and from virtually central portions to fore end portions of the first shaft portion 41, are both provided with first insertion concave portions 46, which function as rotation arresting means.

Furthermore, a second shaft portion 42 is e.g. integrally mounted on a surface on the side of a side end portion which lies close to the end portion of a connecting portion 43 on the side of a second case body 12 and is longer in length (the side end portion may be called side long end portion); the second shaft portion 42 stretches in the right and left direction and the direction of the side long end portion of the connecting portion 43. The second shaft portion 42 supports a second shaft 3, allowing the first case body 11 and the second case body 12 to be rotatable around the second shaft 3. On a surface of the connecting portion 43 inside the second shaft portion 42, a second through hole 43b with a smaller diameter than the second shaft portion 42 is mounted. Two portions opposing each other in the inner circumference of the second shaft portion 42 are both provided with second insertion concave portions 47, which function as rotation arresting means.

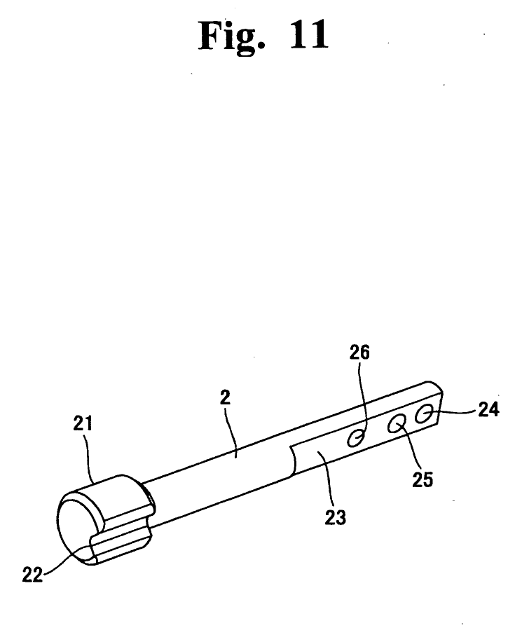

A first shaft 2, as shown in FIGS. 5, 7 and 11, is inserted through a first through hole 43a of a first shaft portion 41 and supported via the first shaft portion 41 to be rotatable. A first shaft 2 is equipped with a first cam portion 21 on one end portion thereof. The first cam portion 21 is formed in a shape of a column with a diameter larger than a first shaft portion 41. The first cam portion 21 is provided with a first cam concave portion 22 on the circumferential surface of the former, stretching in the axial direction and having substantially the shape of U. The first shaft 2 has a diameter smaller, e.g. slightly smaller than a first through hole 43a. The first shaft 2 is formed with such a length that it allows the first cam portion 21 to be located inside a connecting portion 43, and an other end portion, i.e. a fore end portion of the first cam portion 21 to protrude from the first shaft portion 41.

Further insertion portions 23 are made of groove-like incisions on a circumferential surface of a first shaft 2 on a portion which protrudes from a first shaft portion 41; the insertion portions 23 are formed in parallel to each other and both flat. Further on a portion of the first shaft 2 which protrudes from the first shaft portion 41, three mounting holes, i.e. a first mounting hole 24, a second mounting hole 25, and a third mounting hole 26. The first mounting hole 24 and the second mounting hole 25 which are closer to a fore end portion firmly fix the first shaft 2 via mounting members as nuts, volts, etc. to a first case body 11, so as to be removable from the latter. The remaining third mounting hole 26 fixes a first cam A member 61 of a first cam mechanism 6 to the first shaft 2.

A first cam mechanism 6 preferably keeps a first shaft 2 to be locked at a predetermined position at two angles, e.g. 0° and 172°, where, e.g. the first shaft 2 is rotatable with regard to a first shaft portion 41 within a range between 0° and 180°, in other words a second case body 12 can rotate around the first shaft 2 with regard to a first case body 11 within the same range. The angles here are produced from a straight line in the longitudinal direction of a first case body 11 and other line parallel to the one in the longitudinal direction of a second case body 12 (the angles may be called first rotation angles), both lines crossing at the axis of the first shaft 2, and it is preferable that the both case bodies are connected with each other via the first shaft 2 where the angle defined here is 0°, so as to be superimposed on each other, thus realizing the closing condition. In the meanwhile, a reference to 0° in the present invention implies also degrees about 0°. Furthermore, a reference to 172° in the present invention implies also degrees about 172°.

Constituent components of a first cam mechanism 6 are e.g. the following: a first cam A member 61 which is fixed to an outer circumference of a first shaft 2 close to the fore end portion thereof, a first cam B member 62 which is found in a contact on the surface with the first cam A member 61, a first cam engagement convex portions 63 which are mounted at least on either one surface of contact surfaces of the first cam A member 61 and first cam B member 62, e.g. on a contact surface of the first cam B member 62 with the first cam A member 61, first cam engagement concave portions 64 which are mounted on either one surface opposing that with the first cam engagement convex portions 63, e.g. on a contact surface of the first cam A member 61 with the first cam B member 62 for being engaged with the first cam engagement convex portions 63, and a compression coil spring 65 being a biasing means.

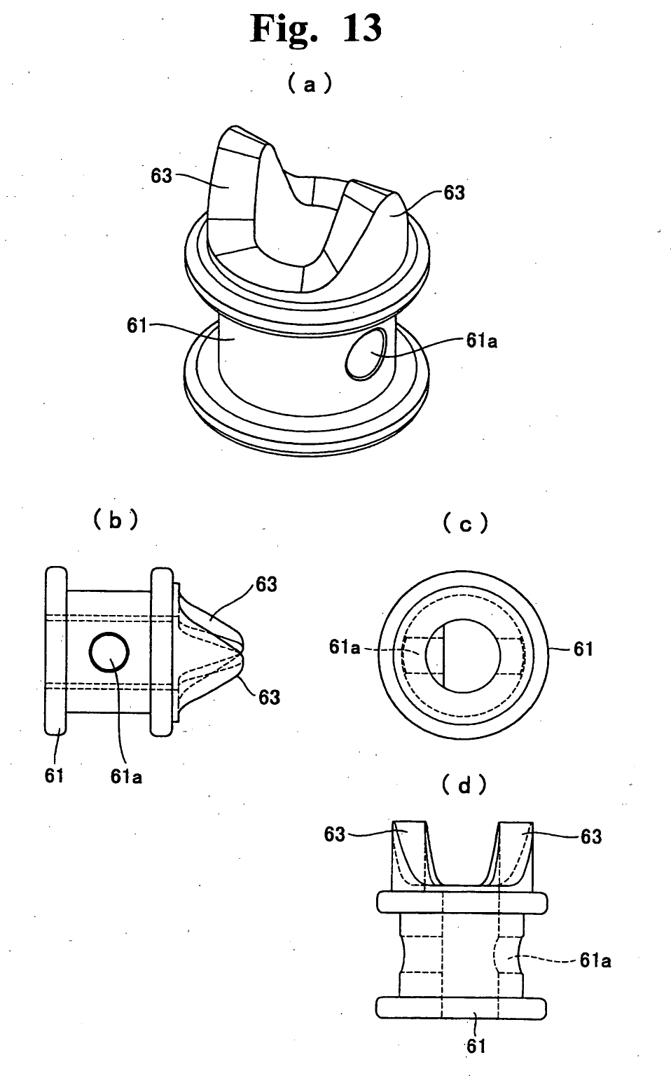

A first cam A member 61 is formed, as shown in FIGS. 7 and 13, e.g. in the shape substantially of a cylinder. The first cam A member 61 has an outer diameter larger than an inner diameter of a first shaft portion 41. The interior (it may be called inner hole) of the first cam A member 61 is formed in the shape in which the inner hole can accommodate an insertion portion 23 of a first shaft 2 to be fitted therewith, without being rotatable. Furthermore the first cam A member 61 is provided with an insertion hole 61a which penetrates in the radial direction thereof. The first cam A member 61 is fixed without rotating on a portion close to the fore end portion of the first shaft 2 by an assembly in which a portion of the insertion portion 23 of the first shaft 2 protruding from the first shaft portion 41 is fitted with the inner hole, and then, mounting members as pins, nuts and bolts, e.g. pins 66 are inserted through the insertion hole 61a adjusted with the third mounting hole 26 at the place of holes, thereupon, end portions of pins 66 are caulked.

On a surface of a first cam A member 61 on the side of a first shaft portion 41 (it may be called contact surface) two first cam engagement convex portions 63 are mounted. The first cam engagement convex portions 63 are mounted at an interval of 180° on the contact surface of the first cam A member 61: two first cam engagement convex portions 63 are symmetrically mounted on the contact surface of the first cam A member 61. The shape of the first cam engagement convex portions 63 is not particularly limited, however, the portions are formed in an R-shape, substantially in the shape of a triangle.

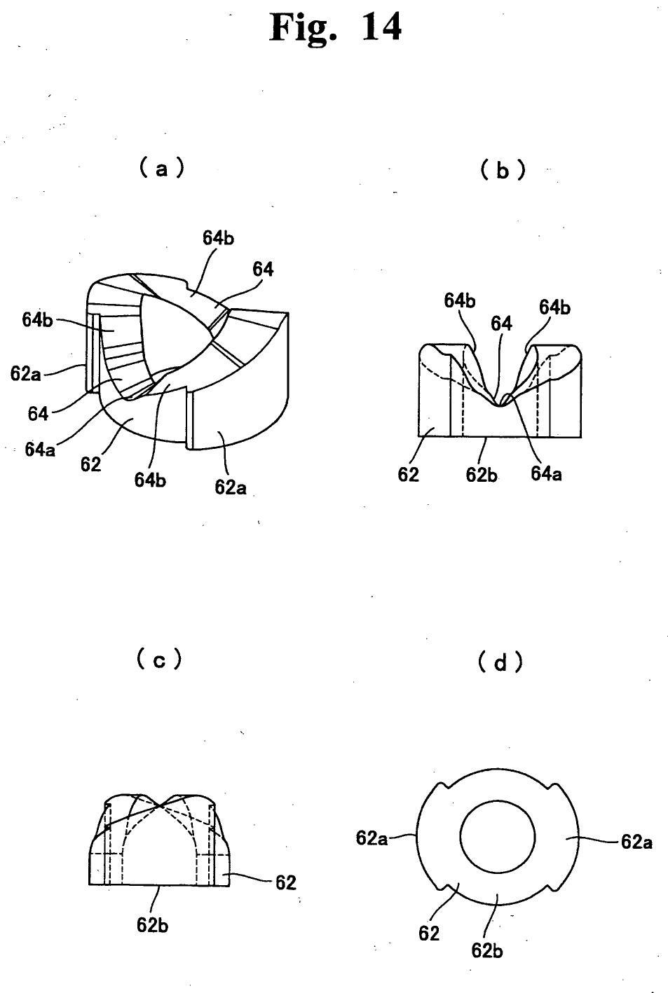

A first cam B member 62 is, as shown in FIGS. 7 and 14, located inside a first shaft portion 41, having a shape virtually of a ring. A contour of the first cam B member 62 is of a size slightly smaller than the profile inside the first shaft portion 41, and of substantially identical shape, i.e., having first insertion convex portions 62a which are made from two protrusions on a circle so as to be fitted with first insertion concave portions 46. A profile inside the first cam B member 62 (it may be called a inner hole thereof) is formed in the shape of circle with a diameter slightly smaller than an outer diameter of the first shaft 2. The first cam B member 62 is mounted on the first shaft 2 which is inserted through the inner hole of the first cam B member 62, and further at assembly the first cam B member 62 is installed inside the first shaft 41 with the first insertion convex portions 62a being engaged with the first insertion concave portions 46; accordingly the first cam B member 62 is movable in the axial direction of the first shaft 2, but not rotatable around the axis.

On a surface of a first cam B member 62 on the side of a first cam A member 61 (it may be called contact surface) two first cam engagement concave portions 64 are mounted at an interval of 180° in the circumferential direction of the first cam B member 62; the first cam engagement concave portions 64 are each to be engaged with the first cam engagement convex portions 63. These two first cam engagement concave portions 64 are symmetrically mounted, and they are located for allowing for an engagement with the first cam engagement convex portions 63 preferably e.g. at −8° and 172° in the first rotation angle. The first rotation angle at which the first cam engagement concave portions 64 are engaged with the first cam engagement convex portions 63 in a closing condition is preferable below 0°, and not limited to −8°, and angles other than −8° are also accepted. In the meanwhile, a reference to −8° in the present invention implies also degrees about −8°.

First cam engagement concave portions 64 are composed of bottom portions 64a and two inclined portions 64b to contain the bottom portions 64a which are located at the position of −8° and 172° in the first rotation angle. The width of the inclined portions 64b is of a size smaller than the range of 90° in the rotation angle, and the most part of the contact surface of a first cam B member 62 is formed as first cam engagement concave portions 64. In other words, little contact surface between first cam engagement concave portions 64 is formed actually. The remaining surface of the first cam B member 62 (it may be called biasing surface 62b) is desirably formed to be flat. A biasing means is preferably mounted between the biasing surface 62b and a wall of a connecting portion 43 inside a first shaft portion 41, in an outer circumference of a first shaft 2.

A biasing means includes e.g. a compression coil spring 65. The compression coil spring 65 is e.g. inserted into an outer circumference of a first shaft 2 and allows one end portion thereof to abut on a wall of a connecting portion 43 inside a first shaft portion 41, and in addition allows another end portion to abut on a biasing surface 62b of a first cam B member 62; the compression coil spring 65 thus pressingly biases the first cam B member 62 toward a first cam A member 61. This movement causes friction forces working on the first cam A member 61 and on the first cam B member 62 both to be increased, enabling the first shaft 2 to be arrested at any position within the rotation range of the first shaft portion 41.

In other words, a first shaft portion 41 is assembled in the following manner: a washer 67 is attached on a first shaft 2 with a fore end portion thereof being inserted through a first through hole 43a; on the other hand, the washer 67 is brought into contact with a wall of a connecting portion 43 outside the first shaft portion 41. At this point a fore end portion of the first shaft 2 protrudes from a fore end portion of the first shaft portion 41. Next, a compression coil spring 65 and a first cam B member 62 are fitted in sequence on an outer circumference of the first shaft 2 from the fore end portion thereof. After these parts being fitted, a first cam A member 61 is inserted through an insertion portion 23 of the first shaft 2, the former thus being attached to the latter; then the first cam B member 62, abutting on the first cam A member 61, is forced into first shaft portion 41 against the biasing force of the compression coil spring 65; a pin 66 e.g. is inserted through the insertion hole 61a and the third mounting hole 26 which have been adjusted in advance to each other, and finally both end portions of the above-mentioned pin 66 are caulked. This is the assembly of the first shaft portion 41, which thus realizes a reduced number of parts therein, an easy integration, and reduced costs.

This paragraph considers a case where a first shaft 2 rotates with regard to a first shaft portion 41 assembled in the above-described manner; if the rotation of a first shaft 2 is arrested at the position where first cam engagement convex portions 63 don't completely escape from first cam engagement concave portions 64, i.e. a fore end portion and portions nearby are contacted with inclined portions 64b of the latter, the first cam engagement convex portions 63 are automatically shifted along the inclined portions 64b toward bottom portions 64a to reach there or portions nearby; thus the movement causes the rotation of the very first cam engagement convex portions 63 to be arrested, realizing the locking condition thereof. In short, the first cam engagement convex portions 63 are to be automatically locked in the above-described case. Concretely a range virtually from 0° to 82° is a closing range in which the first cam engagement convex portions 63 are automatically shifted into the closing condition at 0°, while a range virtually from 82° to 172° is an opening range in which the first cam engagement convex portions 63 are automatically shifted into the opening condition. In the meantime, if an angle and distance between each two of inclined portions 64b of the first cam engagement convex portions 63 is changed at discretion, an automatic locking angle (an angle at which locking condition is automatically realized) can be set at a desired angle.

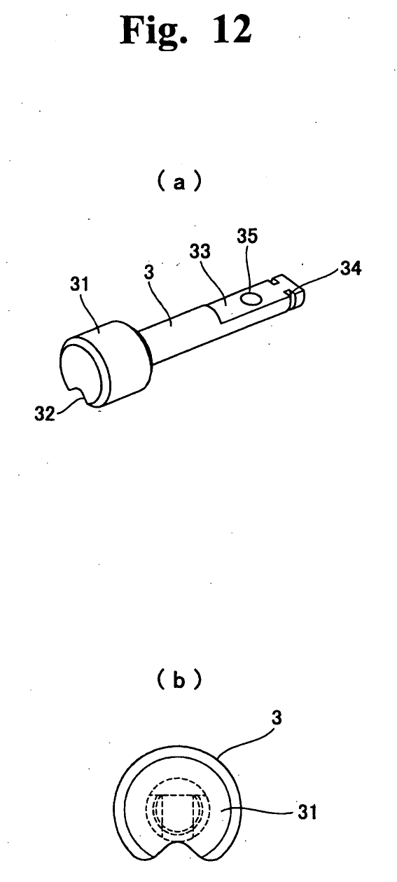

A second shaft 3, as shown in FIGS. 4, 5, 7, and 12, is inserted through a second through hole 43b of a second shaft portion 42 to be rotatably supported by the second shaft portion 42. The second shaft 3 is equipped with a second cam portion 31 on one end portion. The second shaft portion 31 is formed in a shape of a cylinder which has a larger diameter than a second through hole 43b of a second shaft portion 42. A second cam concave portion 32 is mounted on a circumferential surface of the second cam portion 31; the second cam concave portion 32 extends in the axial direction of the second cam portion 31 and has a shape substantially of U. The second shaft 3 is formed to have a diameter smaller, e.g. slightly smaller than the second through hole 43b. The second shaft 3 is so long that the connecting portion 43 can accommodate the second cam portion 31 thereof, and that its fore end portion as another end portion can protrude from a second shaft portion 42.

Furthermore, insertion portions 33 are made of groove-like incisions on a circumferential surface of a second shaft 3 on a portion which protrudes from a second shaft portion 42; the insertion portions 33 are formed in parallel to each other and both flat. The above-mentioned circumferential surface is equipped with attaching grooves 34 close to a fore end portion thereof, to which a retaining ring is to be attached. Moreover, on the portion of the second shaft 3 protruding from the first shaft portion 42, a cam mounting hole 35 is formed, for fixing a second cam A member 71 of a second cam mechanism 7 to the second shaft 3.

A second cam mechanism 7 locks a second shaft 3 at a predetermined position; where the second shaft 3 rotates with regard to a second shaft portion 42, i.e. a second case body 12 rotates around the second shaft 3 with regard to a first case body 11 in a range from 0° to 170°, the above-mentioned mechanism would lock the second shaft 3 preferably e.g. at three angles, 0°, 140° and 170°. The angles here are formed between a straight line parallel to the one in the right and left direction of the first case body 11 and the one in the right and left direction of the second case body 12, both lines crossing at the axis of the second shaft 3 (these angles may be called second rotation angles); when the angle indicated here becomes 0°, it is desirable for the first case body 11 to be superimposed on the second case body 12 to realize a closing condition, and to be connected as such with the latter via the second shaft 3. In the meantime, a reference to 140° in the present invention implies also degrees about 140°, and it is also the case for a reference to 170°.

A second cam mechanism 7 is composed e.g. of a second cam A member 71 which is fixed on an outer circumference of a second shaft 3 close to a fore end portion thereof, of a second cam B member 72 attached to the second shaft 3 and contacted on the surface with second cam A member 71, second cam engagement convex portions 73 formed at least on one of contact surfaces of the second cam A member 71 and second cam B member 72, e.g. on a contact surface of the second cam A member 71 contacted with the second cam B member 72, second cam engagement concave portions 74 formed on a surface opposed to the one with second cam engagement convex portions 73 e.g. on a contact surface of the second cam B member 72 with the second cam A member 71, and a compression coil spring 75 as a biasing means.

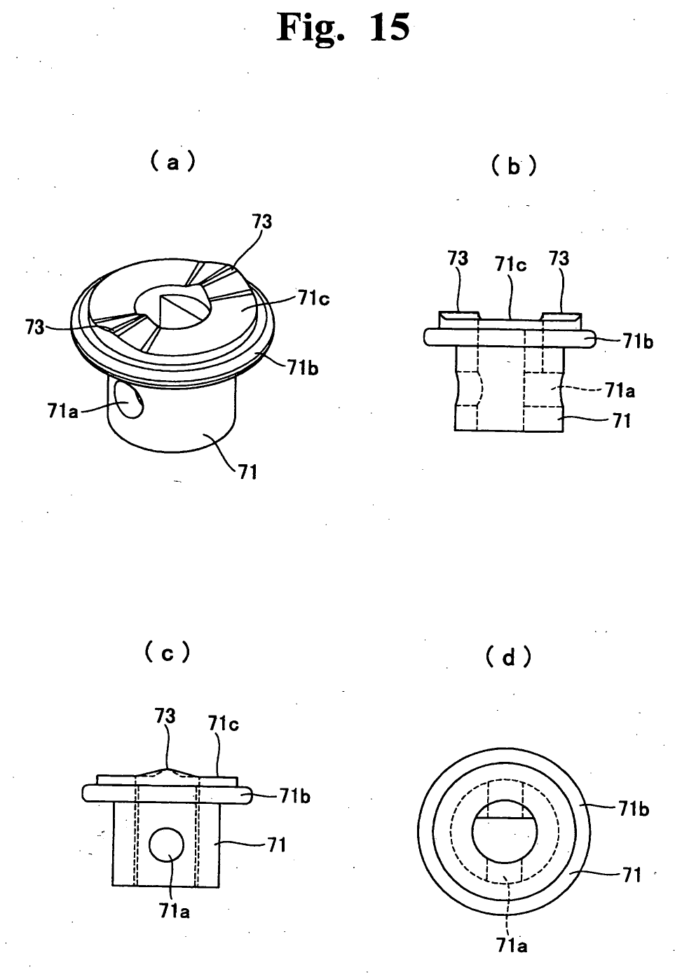

As shown in FIGS. 7 and 15, a second cam A member 71 is formed e.g. in the shape substantially of a cylinder. The second cam A member 71 has an outer diameter larger than an inner diameter of a second shaft portion 42. The interior (it may be called inner hole) of the second cam A member 71 has such a shape that it enables the insertion portion 33 to be inserted into the second cam A member, without rotating around the axis thereof. The second cam A member 71 is also provided with an insertion hole 71a penetrating in the radial direction thereof. The second cam A member 71 is fixed without rotating on a portion close to a fore end portion of the second shaft 3 in the following manner: the insertion portion 33 of the second shaft 3 protruding from the second shaft portion 42 is fitted into the inner hole; then an attaching member such as a pin, a screw, a bolt and others, e.g. a pin 77 is inserted through the insertion hole 71a and a cam mounting hole 35, adjusted with each other at the position; finally both end portions of the pin 77 are caulked.

A second cam A member 71 is provided, on a fore end portion thereof, with a case body mounting member 76 for attaching the second cam A member 71 to the second case body 12. The case body mounting member 76 is equipped with a mounting portion 76a to be attached to a second shaft 3 which don't rotate around it, and mounting holes 76b set on the mounting portion 76a for attaching the second cam A member 71 to the second case body 12 via e.g. screws, bolts, pins, and others.

A second cam A member 71 is equipped, toward a second shaft portion 42, with a cam portion 71b in the shape of a ring. The cam portion 71b has a diameter larger than an inner diameter of a second shaft portion 42. The cam portion 71b is equipped on a fore end portion thereof (it may be called cam surface 71c) with two second cam engagement convex portions 73. The second cam engagement convex portions 73 are set at an interval of 180° on the cam surface 71c of the second cam A member 71. In other words, two of the above-indicated second cam engagement convex portions 73 are located in symmetry on a contact surface. The shape of the second cam engagement convex portions 73 is not particularly limited, but they protrude in the shape virtually of a triangle, which has a shape of letter R on a fore end portion. The cam surface 71c between the second cam engagement convex portions 73 (the cam surface other than the second cam engagement convex portions 73) is desirable to be flat.

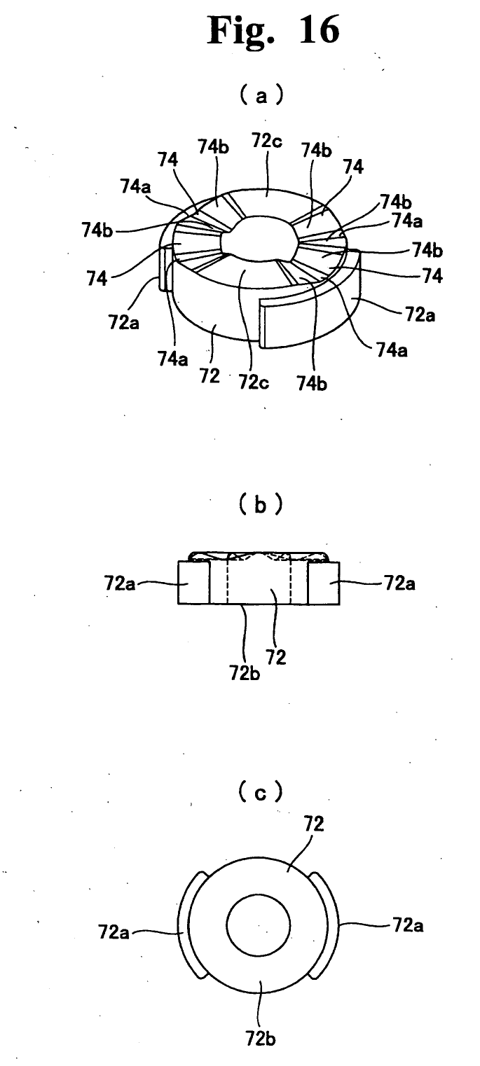

A second cam B member 72 is, as shown in FIGS. 7 and 16, located inside a second shaft portion 42, in the shape approximately of a ring. The outer shape of the second cam B member 72 is formed in a shape which is slightly smaller than the inner shape of a second shaft portion 42, and is substantially the same as it, in other words, a circle with two protrusions are fitted into second insertion concave portions 47; the protrusions are second insertion convex portions 72a. The interior of the second cam B member 72 (it may be called inner hole) is formed in the shape of a circle with a diameter slightly smaller than an outer diameter of a second shaft 3. The second cam B member 72 is attached to the second shaft 3 which is inserted through the inner hole of the second cam B member 72, and in assembly, the second insertion concave portions 47 and the second insertion convex portions 72a are engaged with each other to be installed altogether inside the second shaft portion 42. Accordingly, the second cam B member 72 is movable in an axial direction of the second shaft 3, however, it cannot rotate around the axis.

A second cam B member 72 is equipped on one surface toward the second cam A member 71 (it may be called contact surface 72c) with four second cam engagement concave portions 74 to be each engaged with second cam engagement convex portions 73. Two of the four cam engagement concave portions 74 are set at an interval of 180°, i.e. symmetrically on the contact surface 72c. It is therefore desirable for the above two cam engagement concave portions 74 to be located, enabling an engagement with two of the second cam engagement convex portions 73, e.g. at −10° and 170° in the second rotation angle. One of the second rotation angles at which these two cam engagement concave portions 74 are engaged with their counterparts second cam engagement convex portions 73 is desirably set at a degree less than 0°, and not limited to −10°, and a degree other than −10° is also accepted. In the meantime, any reference to −10° in the present invention implies also degrees around −10°. Furthermore, the remaining cam engagement concave portions 74 are placed at an interval of 180°, i.e. symmetrically on the contact surface 72c, and it is desirable for these portions to be engaged with two second cam engagement convex portions 73, e.g. at 140°.

Each one of second cam engagement concave portions 74 is composed of a bottom portion 74a and two inclined portions 74b to form the bottom portion 74a. The bottom portions 74a are located at −10°, 140°, 170° and 320° respectively, in the second rotation angle. The width of each of the inclined portions 74b is desirably of a size adjusted to a range slightly smaller than 15° in the second rotation angle. Moreover, the contact surface 72c other than four of the second cam engagement concave portions 74 is preferably formed to be flat. Further the remaining surface of the second cam B member 72 (it may be called biasing surface 72b) is preferably formed to be flat. A biasing means is desirably set between the biasing surface 72b and a wall of a connecting portion 43, on an outer circumference of the second shaft 3.

A biasing means is, e.g. a compression coil spring 75. The compression coil spring 75 is fitted onto an outer circumference of a second shaft 3; one end portion of the compression coil spring 75 then abuts on a wall of connecting portion 43, inside a second shaft portion 42, while the other end portion on a biasing surface 72b of a second cam B member 72. Therefore the compression coil spring 75 pressingly biases the second cam B member 72 toward a second cam A member 71. Accordingly friction forces working on the second cam B member 72 and on the second cam A member 71 are each increased, allowing the second shaft 3 to be arrested at any position within the rotation range of the second shaft portion 42.

In other words, a second shaft portion 42 is assembled in the following manner: a washer 78 is attached on a second shaft 3 with a fore end portion thereof being inserted through a second through hole 43b via a second attaching hole 43d of a connecting portion 43; a second cam portion 31 abuts via the washer 78 on a wall outside the second shaft portion 42 of the connecting portion 43. At this point a fore end portion of the second shaft 3 protrudes from a fore end portion of the second shaft portion 42. Next, a compression coil spring 75 and a second cam B member 72 are fitted in sequence on an outer circumference of the second shaft 3 from the fore end portion thereof. After these parts being fitted, a second cam A member 71 is inserted through an insertion portion 33 of the second shaft 3, the former thus being attached to the latter; then the second cam B member 72, abutting on the second cam A member 71, is forced into the second shaft portion 42 against the biasing force of the compression coil spring 75; a pin 77 e.g. is inserted through the insertion hole 71a and the cam mounting hole 35 which have been adjusted in advance to each other, and finally both end portions of the above-mentioned pin 77 are caulked. Thereupon a case body mounting member 76 is fitted onto a fore end portion of the second shaft 3. Then by fixing the case body mounting member 76 with the second shaft 3 using e.g. an E-shape retaining ring 79 to be applied to an attaching groove 34 of the second shaft 3, the second shaft portion 42 is assembled. The second shaft portion 42, with an assembly above described, realizes a reduced number of parts therein, an easy integration, and reduced costs.

Where a second shaft 3 rotates with regard to a second shaft portion 42 assembled in the above-described manner, second cam engagement convex portions 73 of a second cam A member 71 disengage from second cam engagement concave portions 74, and then fore end surfaces of the second cam engagement convex portions 73 automatically slide along a flat contact surface 72c other than the second cam engagement concave portions 74 of a second cam B member 72, keeping a contact therewith. If the rotation of the second shaft 3 is arrested under this contact condition, due to a friction force caused by the contact of fore end surfaces of second cam engagement convex portions 73 with the flat contact surface 72c, the second shaft 3 stops at the position. This condition is defined free stop condition, and a second rotation angle in this condition is called free stop angle.

This paragraph considers a case where a second shaft 3 rotates with regard to a second shaft portion 42 assembled in the above-described manner; if the rotation of the second shaft 3 is arrested at a position where second cam engagement convex portions 73 are not completely disengaged from second cam engagement concave portions 74, i.e. a fore end portion and portions nearby of the former are contacted with one of inclined portions 74b of the latter, the second cam engagement convex portions 73 each automatically slide along one of the inclined surfaces 74b toward a bottom portion 74a to reach there or portions nearby; thus the movement causes the rotation of the very second cam engagement convex portions 73 to stop, realizing the locking condition thereof. In short, the second cam engagement convex portions 73 are to be automatically locked in the above-described case. In the meantime, if an angle and distance between each two of the inclined surfaces of the second cam engagement concave portions 74 is changed at discretion, automatic locking angle (an angle at which locking condition is automatically realized) can be set at a desired angle.

Where a first case body 11 and a second case body 12 can be closed or opened from a closing condition in either one of two directions, a locking mechanism 5, as shown in FIGS. 4 and 7, locks both case bodies closed or opened in either one of directions to be in a condition other than closing condition, against being closed or opened in the other direction. Any formation is possible for the locking mechanism 5; it is equipped, e.g. with a locking member 51 installed inside a connecting portion 43. The locking member 51 is comprised of a locking shaft 52 in the shape of a bar with a circular cross section and a biasing means for biasing the locking shaft 52.

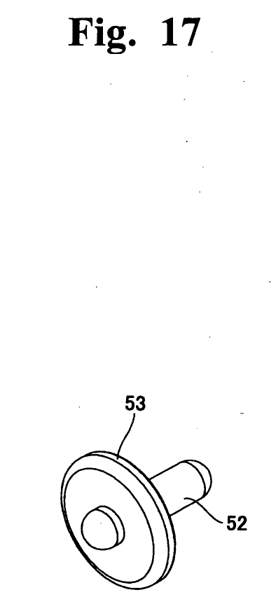

A locking shaft 52, as shown in FIGS. 4, 7, 8 and 17, is formed with a diameter slightly smaller than an inner diameter of a penetrating portion 45 of a compartment wall 44 inside a connecting portion 43. As for length of the locking shaft 52, to which a first cam concave portion 22 and a second cam concave portion 32 of a first shaft 2 are each opposed, it is desirable for the locking shaft 52 to have a length which allows for the following movement: when one end portion of the locking shaft 52 gains entrance into the first cam concave portion 22 to be engaged therewith, the other end portion of the locking shaft 52 will desirably separate from the first cam concave portion 22 to avoid an engagement therewith; on the other hand, where the other end portion of the locking shaft 52 gains entrance into the second cam concave portion 32 to be engaged therewith, it is desirable for one end portion of the locking shaft 52 to separate from the second cam concave portion 32 to avoid an engagement therewith. In short, it is favorable for the locking shaft 52 to be so long as to allow an engagement of either one of the end portions with either one of the cam concave portions 22 and 32. In the meantime, the first shaft 2 and second shaft 3 are so located on a first case body 11 and a second case body 12 respectively that the first case body 11 and the second case body 12 become completely opened while the first cam concave portion 22 and the second cam concave portion 32 each face to the locking shaft 52.

Furthermore, a locking shaft 52 is equipped with a biasing portion 53 at a point other than an end portion, toward a second shaft 3 inside a connecting portion 43. The biasing portion 53 has e.g. a shape of a ring in a radial direction of a locking shaft 52, on an outer circumference thereof. It is desirable for the biasing portion 53 to have a diameter larger than a penetrating portion 45 and smaller than the smallest distance inside the connecting portion 43. In addition a locking shaft 52 is provided with a biasing means on an outer circumference, between the biasing portion 53 and a compartment wall 44.

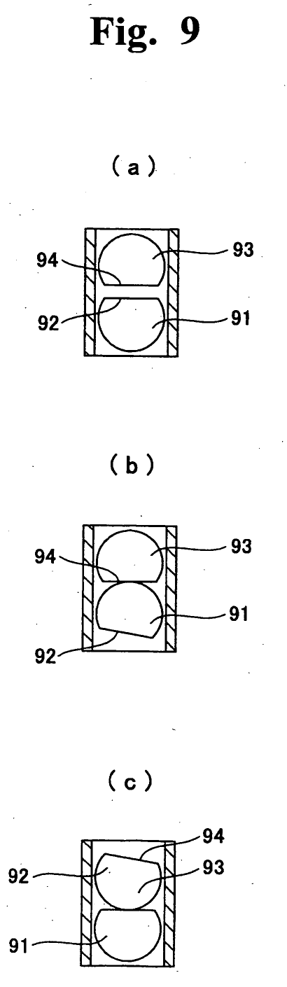

A biasing means includes e.g. a compression coil spring 54 fitted onto an outer circumference of a locking shaft 52; one end portion of the compression coil spring 54 abuts on a biasing portion 53, while the other end portion thereof abuts on a compartment wall 44; the compression coil spring 54 thus biases the locking shaft 52 to allow for an engagement of an end portion thereof with a second cam concave portion 32. In addition, although in the present invention it is indicated that the compression coil spring 54 thus biases the locking shaft 52 to enable an engagement thereof with a second cam concave portion 32, it is also possible that the above-indicated compression coil spring biases the locking shaft 52 which is to be engaged with a first cam concave portion 22. Furthermore, herein the locking shaft 52 is installed to be biased via a compression coil spring for an engagement with either one of the cam concave portions, however, it is also possible that the locking shaft is engaged with either one of cam end portions, without use of a compression coil spring. Moreover, in spite of an indication herein that a closing/opening operation via a first and a second shaft is restricted by means of a locking shaft, other structures without requiring use of a locking shaft for restricting a closing/opening operation via a first and a second shaft, are also allowed. For example, an embodiment illustrated in FIG. 9 is also possible: herein a first cam portion 91 of the first shaft 2 approaches to a second cam portion 93 of the second shaft 3; the former is equipped with a first cam engagement portion 92, while the latter with a second cam engagement portion 94; thus in the closing condition, the first cam engagement portion 92 and the second cam engagement portion 94 are opposed to each other, enabling a closing/opening operation via either one of the first and the second shaft (see FIG. 9A), further in any condition except the closing condition, i.e. where the first or the second shaft rotates to close the both case bodies, the second cam engagement portion 94 of the second shaft or the first cam engagement portion 92 of the first shaft, whichever portion with a shaft not operating, is engaged with the second cam portion 93 or the first cam portion 91 respectively, locking the shaft not operating against opening and closing (see FIGS. 9B and 9C).

A locking mechanism 5 is assembled in a following manner: first a compression coil spring 54 is fitted onto an outer circumference of a locking shaft 52, which is afterwards inserted inside a connecting portion 43 through an aperture on one end portion on the side of a second shaft portion 42 thereof. A biasing means 53 is shifted toward a compartment wall 44 against the biasing force of the compression coil spring 54 and thus pressed farther inside the connecting portion 43, enabling a mounting of the second shaft 3 into the second shaft portion 42. After a mounting of the second shaft 3, the biasing portion 53 is released from a pressing insertion into the connecting portion 43. Thereupon, other end portion of the locking shaft 52 is shifted to reach to a second cam portion 31 of the second shaft 3. If at this point a second cam concave portion 32 does not face the locking shaft 52, the second shaft 3 is rotated to allow the former to face the latter. This will cause other end portion of the locking shaft 52 to be inserted into the second cam concave portion 32 and engaged therewith. The above is the assembly of the locking mechanism 5. Herewith a hinge device according to the present invention itself is assembled. Accordingly the number of the parts therein is reduced, making an integration easier and costs reduced.

In the following the function of a hinge device 1 of portable equipment and a portable telephone 10 according to the present invention will be described.

When a portable telephone 10 is out of use in a closing condition, usually, as shown in FIG. 1, a first case body 11 and a second case body 12 are superimposed on each other, being two-folded. Under this condition a first rotation angle is 0°, and the both case bodies are locked to each other, with first cam engagement convex portions 63 being engaged with first cam engagement concave portions 64. Thus a closing condition, where the first case body 11 and the second case body 12 are superimposed on each other and two-fold, is retained due to an engagement of the first cam engagement convex portions 63 with the first cam engagement concave portions 64, such engagement however does not provide a complete (also substantially complete) fitting for the above-identified portions to be engaged, but a mere insertion of portions of the first cam engagement convex portions 63 into the first cam engagement concave portions 64. Accordingly the first case body 11 and the second case body 12 are retained in the closing condition without shaking.

In other words, first cam engagement concave portions 64 are located, allowing an engagement with first cam engagement convex portions 63 at −8°, and not at 0° in the first rotation angle, and therefore fore end portions of the first cam engagement convex portions 63 are contacted with inclined portions 64b of the first cam engagement concave portions 64 to gain an incomplete entrance into the first cam engagement concave portions 64, thus being engaged with the latter without being completely (also substantially completely) fitted. In other words, a condition in which the first cam engagement convex portions 63 are about to be shifted toward bottom portions 64a of the first cam engagement concave portions 64 is a closing condition in which a first case body 11 and a second case body 12 are superimposed on each other and two-fold. As a result, at 0° in the first rotation angle, the second case body 12, being biased in seeking for a complete (also substantially complete) fitting, realize a close contact with the first case body 11, retaining both case bodies without shaking in a closing condition.

Further in a closing condition, a second rotation angle is 0°, and a first case body 11 and a second case body 12 are locked to each other, where second cam engagement convex portions 73 are engaged with second cam engagement concave portions 74. Thus a closing condition, where the first case body 11 and the second case body 12 are superimposed on each other and two-fold, is retained due to an engagement of the second cam engagement convex portions 73 with the second cam engagement concave portions 74, such engagement however does not provide a complete (also substantially complete) fitting for the above-identified portions to be engaged, but a mere insertion of portions of the second cam engagement convex portions 73 into the second cam engagement concave portions 74. Accordingly the first case body 11 and the second case body 12 are retained in the closing condition without shaking.

In other words, second cam engagement concave portions 74 are located for allowing an engagement with second cam engagement convex portions 73 at −10°, and not at 0°, and therefore fore end portions of the second cam engagement convex portions 73 are contacted with inclined portions 74b of the second cam engagement concave portions 74 to gain an incomplete entrance into the second cam engagement concave portions 74, thus being engaged with the latter without being completely (also substantially completely) fitted. In other words, a condition in which the second cam engagement convex portions 73 are about to be shifted toward bottom portions 74a of the second cam engagement concave portions 74 is a closing condition, where a first case body 11 and a second case body 12 are superimposed on each other and two-fold. As a result, at 0° in the second rotation angle, the second case body 12, being biased in seeking for a complete (also substantially complete) fitting, realize a close contact with the first case body 11, retaining both case bodies without shaking in a closing condition.

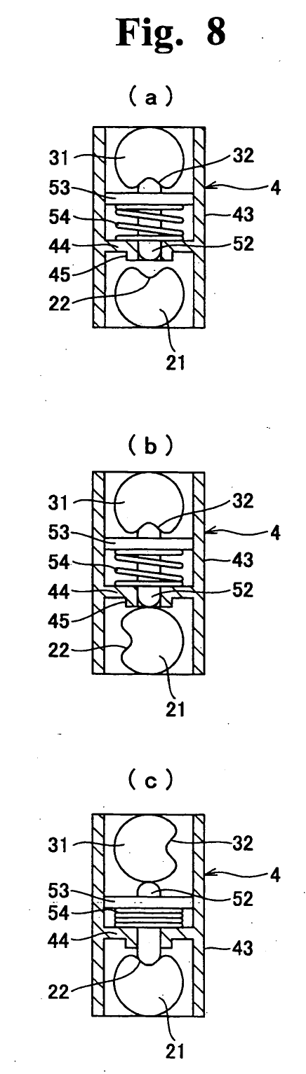

Further in a closing condition, as shown in FIGS. 7 and 8A, other end portion of a locking shaft 52 intrudes into a second cam concave portion 32 to be engaged therewith, enabling a first case body 11 and a second case body 12 to be opened and closed around a first shaft 2. In addition, since one end portion of the locking shaft 52 is opposed to a first cam concave portion 22, other end portion of the locking shaft 52 can disengage from the second cam concave portion 32; therefore the first case body 11 and the second case body 12 can be also opened and closed around a second shaft 3. Accordingly the first case body 11 and the second case body 12 can be opened and closed in either one direction of two aforementioned directions.

For a call with a portable telephone 10, as shown in FIGS. 2 and 4, while a user has e.g. a first case body 11 on his left hand and a second case body 12 on his right hand, the latter is rotated around a first shaft 2 in a direction in which it disengages from the former (i.e. the latter is opened): the first shaft 2 is rotated with regard to a first shaft 41. The above movement allows first cam engagement convex portions 63 to escape from first cam engagement concave portions 64 (the former are released from an engagement with the latter), and at 172° over substantially 82°, the first cam engagement convex portions 63 intrude into the first cam engagement concave portions 64 to be engaged therewith and finally kept locked. In other words, the second case body 12 is exposed and available to a call. Accordingly a call can be achieved.

Along with the rotation of a first shaft 2, a first shaft portion 21 thereof also rotates and a second cam concave portion 32 opposed to one end portion of a locking shaft 52 becomes displaced out of the original position. Concretely one end portion of the locking shaft 52, as shown in FIG. 8B, approaches to a circumferential surface of the first shaft portion 21. Therefore, other end portion of the locking shaft 52 is engaged with the second cam concave portion 32 without disengaging, as a result a first case body 11 and a second case body 12 are never closed, nor opened around a second shaft 3. Thus the first case body 11 and the second case body 12 are not opened and closed in other direction, allowing for a smooth closing/opening of both case bodies. Accordingly, such closing/opening operation is realized easily.

For a reversion of a second case body 12, e.g. on user's right hand, to the original position after a call, the second case body 12 is rotated around a first shaft 2 in a closing direction which is opposite to an opening direction, i.e. a direction in which the second case body 12 approaches to a first case body 11, which is e.g. on user's left hand. This movement allows first cam engagement convex portions 63 to be released from an engagement with first cam engagement concave portions 64; at 0° in the first rotation angle, the former intrude into the latter to be engaged therewith and finally kept locked. Thus the first case body 11 and the second case body 12 revert to a closing condition, which is an original position.

While communication lines like internet are used in a portable telephone 10, a second case body 12 is rotated around a first shaft 2 in an opening direction up to 172° e.g. in a first rotation angle. Through this operation communication lines like internet are available. Furthermore, if a screen of a display portion is used with the screen opened in the right and left direction of a keyboard portion, a second case body 12 is rotated around a second shaft 3 in a direction in which it is disengaged from a first case body 11 (i.e. the former and the latter are opened) at 0° in a second rotation angle, i.e. in a closing condition. In other words, the second shaft 3 is rotated with regard to the second shaft portion 42. The above movement allows second cam engagement convex portions 73 to escape from second cam engagement concave portions 74 (the former are released from an engagement with the latter), and at 140° or at 170° over 140°, the second cam engagement convex portions 73 intrude into the second cam engagement concave portions 74 to be engaged therewith, and finally kept locked. In addition, while fore end portions of the second cam engagement convex portions 73 are released from the second cam engagement concave portions 74 to be slid with contact on flat contact surface 72c other than the second cam engagement concave portions 74 of a second cam B member 72, by a check of the rotation of the second case body 12, the case body stops at the position due to a friction force caused by a contact of the fore end portions of the second cam engagement convex portions 73. In other words, if the second rotation angle is a free stop angle, the second case body 12 can be arrested at the angle. Accordingly, in case of a use of communication lines like internet in the portable telephone 10, the second case body 12 stops at more positions with regard to the first case body 11, enabling a favorable use of communication lines like internet.

When a second shaft 3 rotates, followed by a rotation of a second shaft portion 42 of a second shaft 3, a locking shaft 52 is released from an engagement with a second cam concave portion 32. In other words, along with an escape of other end portion of the locking shaft 52 from the second cam concave portion 32, one end portion thereof intrudes into a first cam concave portion 22 to be engaged therewith, and kept locked. Other end portion of the locking shaft 52, as shown in FIG. 8C, is contacted with a circumferential surface of a second cam concave portion 32 or in vicinity thereof due to a displacement of the second cam concave portion 32, accordingly one end portion of the locking shaft 52 is not released from an engagement with the first cam concave portion 22. Therefore, the first case body 11 and the second case body 12 are neither closed nor opened around a first shaft 2, realizing smoothly an opening and closing of the first case body 11 and the second case body 12. As a result, this structure facilitates an opening and closing operation.

Therefore, in a hinge device 1 of portable equipment and a portable telephone 10 according to the present invention, a first case body 11 and a second case body 12, when opened and closed from a closing condition in either one of two directions, are locked against opening and closing in other direction and exclude this movement, thus facilitating a closing/opening operation. Furthermore, the number of parts therein is reduced, realizing an easy integration and reduced costs; a favorable operation for a call and a use of communication lines like internet in an optimal condition are also realized by this invention.

As described above, in a hinge device of portable equipment according to the present invention a first case body and a second case body, when opened and closed from a closing condition in either one of two directions, are locked against opening and closing in other direction and exclude this movement, thus facilitating a closing/opening operation, thus making the aforementioned device particularly suitable for a hinge device for a portable telephone among various portable terminals.

What is claimed is:

1. A hinge device of a portable equipment for relatively opening and closing a first case body and a second case body of said portable equipment in either one of two directions, a longitudinal direction and a right and left direction, from a closing condition, where a first case body and a second case body are superimposed on each other, said hinge device comprising:
a first shaft attached to either one of said first case body and said second case body;
a second shaft attached to either other one of said first case body and said second case body;
a base portion for supporting said first shaft and said second shaft so as to be each rotatable around a respective axis;
a first cam mechanism for restricting the rotation of said first shaft with regard to the base portion;
a second cam mechanism for restricting the rotation of said second shaft with regard to the base portion;
a locking mechanism for allowing said first case body and said second case body, when said first case body and said second case body are in a closing condition, to be opened and closed in said two directions, and for locking said first case body and said second case body against closing/opening in either other direction when said first case body and said second case body are opened in either one direction of said two directions.

2. A hinge device of a portable equipment according to claim 1:
wherein said locking mechanism is composed of a first cam attached to said first shaft for rotating together with said first shaft, a second cam attached to said second shaft for rotating with the second shaft, and a locking member to be engaged with one of said first shaft and said second shaft so as to be locked, when other one of said first shaft and said second shaft rotates to be opened in either one of two of said directions.

3. A hinge device of a portable equipment according to claim 2:
wherein said first cam is formed in the shape of a circle and has first cam engagement concave portions on an outer circumference thereof;
wherein said second cam is formed in the shape of a circle and has second cam engagement concave portions on an outer circumference thereof;
wherein said locking member has a locking shaft to be movable and to shuttle between said first shaft and said second shaft;
wherein said locking shaft prevents either one of said first shaft and said second shaft from rotating, by an intrusion of cam engagement convex portions into cam engagement concave portions of said first cam or said second cam, to be opened in either other one of two of said directions, when said first case body and said second case body are opened in either one of two of said directions.

4. A hinge device of a portable equipment according to claim 3,
wherein said locking shaft is automatically biased to be engaged either with said first cam engagement concave portions or with said second cam engagement concave portions.

5. A hinge device of a portable equipment according to claim 1,
wherein said locking mechanism has a first cam attached to said first shaft with a cam portion and a second cam attached to said second shaft with a cam portion;
wherein a rotation of either one of said first shaft and said second shaft is prevented by being engaged with a portion other than a cam portion of either other one of said first shaft and said second shaft, when said first case body and said second case body are opened by rotation of either other one of said first shaft and said second shaft.

6. A hinge device of a portable equipment according to claim 1,
wherein said first cam mechanism is composed of a first cam A member fixed on said first shaft, a first cam B member which is engaged with said base portion, able to be shifted in an axial direction of said first shaft and contacted on the surface with said first cam A member, first cam engagement convex portions mounted at least on either one of contact surfaces of said first cam A member and said first cam B member, and first cam engagement concave portions which are mounted at least on either other one of contact surfaces of said first cam A member and said first cam B member and engaged with said first cam engagement convex portions, for locking said first case body at a predetermined position with regard to said second case body;
wherein said second cam mechanism is composed of a second cam A member fixed on said second shaft, a second cam B member which is engaged with said base portion, able to be shifted in an axial direction of said second shaft and contacted on the surface with said second cam A member, second cam engagement convex portions mounted at least on either one of contact surfaces of said second cam A member and said second cam B member, and second cam engagement concave portions which are mounted at least on either other one of contact surfaces of said second cam A member and said second cam B member and engaged with said second cam engagement convex portions, for locking said second case body at a predetermined position with regard to said first case body.

7. A portable telephone provided with a hinge device of a portable equipment according to claim 1.

8. A portable telephone provided with a hinge device of a portable equipment according to claim 2.

9. A portable telephone provided with a hinge device of a portable equipment according to claim 3.

10. A portable telephone provided with a hinge device of a portable equipment according to claim 4.

11. A portable telephone provided with a hinge device of a portable equipment according to claim 5.

12. A portable telephone provided with a hinge device of a portable equipment according to claim 6.
